(19) United States
(12) Patent Application Publication
(10) Pub. No.: US 2022/0366513 A1
(43) Pub. Date: Nov. 17, 2022

(54) METHOD AND APPARATUS FOR CHECK FRAUD DETECTION THROUGH CHECK IMAGE ANALYSIS

(71) Applicant: JPMorgan Chase Bank, N.A., New York, NY (US)

(72) Inventors: Sambasiva R. Vadlamudi, Chadds Ford, PA (US); Ramana Nallajarla, Hockessin, DE (US); Evgeni Eisenstein, Berkeley Heights, NJ (US); Ehsan Fathi, New York, NY (US)

(73) Assignee: JPMorgan Chase Bank, N.A., New York, NY (US)

(21) Appl. No.: 17/320,804

(22) Filed: May 14, 2021

(51) Int. Cl. G06Q 40/00; G06Q 20/40; H04L 9/32; G06N 20/00

(52) U.S. Cl. CPC G06Q 40/128; G06Q 20/4016; H04L 9/3247; G06N 20/00

(57) ABSTRACT

Various methods, apparatuses, and media for implementing a check fraud detection module are provided. A processor parses received digital image of a check into separate portions, one of the portions including a signature of an account holder. The processor applies a machine learning model to generate a new 128-dimensional embedding of the signature of the account holder parsed from the received digital image of the check and compares it preauthorized historical reference 128-dimensional embedding of the signature stored onto a database. The processor generates, based on comparing, a similarity score between the new 128-dimensional embedding of the signature and the preauthorized historical reference 128-dimensional embedding of the signature; and identifies whether the received check is fraudulent or not based on the generated similarity score.

### TECHNICAL FIELD

This disclosure generally relates to check fraud detection, and, more particularly, to methods and apparatuses for automatically detecting and identifying fraudulent checks through check image analysis by utilizing neural networks, machine learning models, and graphics processing units (GPUs).

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Unfortunately, fraudulent checks are in the rise in today's economy. For example, as online banking use increases in recent years, deposits of fraudulent checks are on the rise as well. A significant portion of the financial losses due to undetected fraudulent checks, however, usually rest on the financial institutions. Major financial institutions (e.g., banks) typically absorb hundreds of thousands of dollars in fraud losses every month due to fraudulent checks deposits or in-clearing fraudulent checks.

Typically, a financial institution may handle two different workflows for physical checks: 1) deposit check—the financial institution's customers deposit checks issued by someone else (may or may not be a customer of the financial institution) into their account: 2) in-clearing—the financial institution's customers write checks to someone else (may or may not be a customer of the financial institution) who then deposits the checks into their account and the check arrives at the financial institution for clearing. In both cases, the problem may arise in identifying fraudulent checks and denying processing of the fraudulent checks in a timely manner. Conventional systems may include a process of out sorting suspicious checks and then manually reviewing the out sorted suspicious checks which may take several days after the transaction date. Because of low precision, most fraudulent checks are posted to the customer account and later reverted. This may negatively impact customer experience.

### SUMMARY

The present disclosure, through one or more of its various aspects, embodiments, and/or specific features or sub-components, provides, among others, various systems, servers, devices, methods, media, programs, and platforms for implementing a fraud check detection module for automatically detecting and identifying fraudulent checks through check image analysis by utilizing neural networks, machine learning models, and graphics processing units (GPUs), thereby identifying whether a check is fraudulent in real-time upon receiving a digital image of the check. The various aspects, embodiments, features, and/or sub-components provide optimized processes of implementing a check fraud detection module in which the generated proprietary real-time fraud detection model (FDM) may handle a large number of received digital images of checks and multiple data sources required by machine learning models, executing the FDMs in real-time using deployment of multiple neural networks in one platform built using a cluster of GPUs and central processing units (CPUs). The check fraud detection module may comprise of compute clusters that implement proprietary machine learning algorithms, using strategic commodity hardware and open-source software reducing overall cost of operations.

According to an aspect of the present disclosure, a method for implementing a check fraud detection module to detect a fraudulent check by utilizing one or more processors and one or more memories is disclosed. The method may include: providing a database that stores preauthorized historical reference 128-dimensional embedding of a signature relating to an account holder; receiving a digital image of a check that includes a signature of the account holder: parsing the digital image of the check into separate portions, one of the portions including the signature of the account holder; applying a machine learning model to generate a new 128-dimensional embedding of the signature of the account holder parsed from the received digital image of the check; comparing the new 128-dimensional embedding of the signature with the preauthorized historical reference 128-dimensional embedding of the signature by accessing the database; generating, based on comparing, a similarity score between the new 128-dimensional embedding of the signature and the preauthorized historical reference 128-dimensional embedding of the signature; identifying whether the received check is fraudulent or not based on the generated similarity score.

According to another aspect of the present disclosure, the method may further include: identifying that the received check is not fraudulent based on a determination that the similarity score is a value that is at or above a predetermined threshold value; and automatically authorizing processing of the received check.

According to yet another aspect of the present disclosure, the method may further include: integrating the new 128-dimensional embedding of the signature with the preauthorized historical reference 128-dimensional embedding of the signature: and updating the machine learning model by automatically incorporating model changes, due to integration of the new 128-dimensional embedding of the signature with the preauthorized historical reference 128-dimensional embedding of the signature, without recoding the model changes.

According to an aspect of the present disclosure, the method may further include: identifying that the received check is fraudulent based on a determination that the similarity score is a value that is below a predetermined threshold value: and automatically denying processing of the received check.

According to another aspect of the present disclosure, the method may further include: transmitting the received check, that has been determined to be fraudulent, to a computing device for visual inspection of the signature in the received check with a preauthorized historical reference signature of the account holder.

According to a further aspect of the present disclosure, the method may further include: automatically notifying the account holder via an electronic message or voice message that the received check has been denied for further processing, but the disclosure is not limited thereto.

According to yet another aspect of the present disclosure, the method may further include: utilizing any one of the following as an open source framework to model the machine learning model: Java Spring Boot, Cassandra, LogStash, Kibana, and Kafka, but the disclosure is not limited thereto.

According to yet another aspect of the present disclosure, the step of applying a machine learning model may further include: generating a stack of neural networks models; and utilizing a graphics processing unit (GPU) based cluster to execute a plurality of neural networks models from the stack of neural networks models for the received digital image of the check to identify whether the received check is fraudulent.

According to a further aspect of the present disclosure, a system for implementing a check fraud detection module to detect a fraudulent check is disclosed. The system may include a database that stores preauthorized historical reference 128-dimensional embedding of a signature relating to an account holder; and a processor operatively connected to the database via a communication network. The processor may be configured to: receive a digital image of a check that includes a signature of the account holder; parse the digital image of the check into separate portions, one of the portions including the signature of the account holder: apply a machine learning model to generate a new 128-dimensional embedding of the signature of the account holder parsed from the received digital image of the check; compare the new 128-dimensional embedding of the signature with the preauthorized historical reference 128-dimensional embedding of the signature by accessing the database; generate, based on comparing, a similarity score between the new 128-dimensional embedding of the signature and the preauthorized historical reference 128-dimensional embedding of the signature; and identify whether the received check is fraudulent or not based on the generated similarity score.

According to another aspect of the present disclosure, the processor may be further configured to: identify that the received check is not fraudulent based on a determination that the similarity score is a value that is at or above a predetermined threshold value; and automatically authorize processing of the received check.

According to a further aspect of the present disclosure, the processor may be further configured to: apply a neural network to convert the printed or handwritten “Pay to the order of” field to text, identify that a check is fraudulent based on suspicious “Pay to the order of” entries, identify that a check is not fraudulent based on safe “Pay to the order of” entries.

According to yet another aspect of the present disclosure, the processor may be further configured to: integrate the new 128-dimensional embedding of the signature with the preauthorized historical reference 128-dimensional embedding of the signature; and update the machine learning model by automatically incorporating model changes, due to integration of the new 128-dimensional embedding of the signature with the preauthorized historical reference 128-dimensional embedding of the signature, without recoding the model changes.

According to an aspect of the present disclosure, the processor may be further configured to: identify that the received check is fraudulent based on a determination that the similarity score is a value that is below a predetermined threshold value: and automatically deny processing of the received check.

According to another aspect of the present disclosure, the processor may be further configured to: transmit the received check, that has been determined to be fraudulent, to a computing device for visual inspection of the signature in the received check with a preauthorized historical reference signature of the account holder.

According to a further aspect of the present disclosure, the processor may be further configured to: automatically notify the account holder via an electronic message or voice message that the received check has been denied for further processing, but the disclosure is not limited thereto.

According to yet another aspect of the present disclosure, the processor may be further configured to: utilize any one of the following as an open source framework to model the machine learning model: Java Spring Boot, Cassandra, LogStash, Kibana, and Kafka, but the disclosure is not limited thereto.

According to yet another aspect of the present disclosure, in applying a machine learning model, the processor may be further configured to: generate a stack of neural networks models; and utilize a graphics processing unit (GPU) based cluster to execute a plurality of neural networks models from the stack of neural networks models for the received digital image of the check to identify whether the received check is fraudulent.

According to an aspect of the present disclosure, a non-transitory computer readable medium is disclosed. The non-transitory computer readable medium may be configured to store instructions for implementing a check fraud detection module to detect a fraudulent check, wherein when executed, the instructions may cause a processor to perform the following: accessing a database that stores preauthorized historical reference 128-dimensional embedding of a signature relating to an account holder; receiving a digital image of a check that includes a signature of the account holder: parsing the digital image of the check into separate portions, one of the portions including the signature of the account holder; applying a machine learning model to generate a new 128-dimensional embedding of the signature of the account holder parsed from the received digital image of the check; comparing the new 128-dimensional embedding of the signature with the preauthorized historical reference 128-dimensional embedding of the signature by accessing the database; generating, based on comparing, a similarity score between the new 128-dimensional embedding of the signature and the preauthorized historical reference 128-dimensional embedding of the signature: and identifying whether the received check is fraudulent or not based on the generated similarity score.

According to another aspect of the present disclosure, the instructions, when executed, may cause the processor to further perform: identifying that the received check is not fraudulent based on a determination that the similarity score is a value that is at or above a predetermined threshold value; and automatically authorizing processing of the received check.

According to yet another aspect of the present disclosure, the instructions, when executed, may cause the processor to further perform: integrating the new 128-dimensional embedding of the signature with the preauthorized historical reference 128-dimensional embedding of the signature; and updating the machine learning model by automatically incorporating model changes, due to integration of the new 128-dimensional embedding of the signature with the preauthorized historical reference 128-dimensional embedding of the signature, without recoding the model changes.

According to an aspect of the present disclosure, the instructions, when executed, may cause the processor to further perform: identifying that the received check is fraudulent based on a determination that the similarity score is a value that is below a predetermined threshold value; and automatically denying processing of the received check.

According to another aspect of the present disclosure, the instructions, when executed, may cause the processor to further perform: transmitting the received check, that has been determined to be fraudulent, to a computing device for visual inspection of the signature in the received check with a preauthorized historical reference signature of the account holder.

According to a further aspect of the present disclosure, the instructions, when executed, may cause the processor to further perform: automatically notifying the account holder via an electronic message or voice message that the received check has been denied for further processing, but the disclosure is not limited thereto.

According to yet another aspect of the present disclosure, the instructions, when executed, may cause the processor to further perform: utilizing any one of the following as an open source framework to model the machine learning model: Java Spring Boot, Cassandra, LogStash, Kibana, and Kafka, but the disclosure is not limited thereto.

According to yet another aspect of the present disclosure, in applying a machine learning model, the instructions, when executed, may cause the processor to further perform: generating a stack of neural networks models: and utilizing a graphics processing unit (GPU) based cluster to execute a plurality of neural networks models from the stack of neural networks models for the received digital image of the check to identify whether the received check is fraudulent.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a check fraud detection device in accordance with an exemplary embodiment.

FIG. 2 illustrates an exemplary diagram of a network environment of a check fraud detection device in accordance with an exemplary embodiment.

FIG. 3 illustrates a system diagram for implementing a check fraud detection device having a check fraud detection module in accordance with an exemplary embodiment.

FIG. 4 illustrates a system diagram for implementing a check fraud detection module in accordance with an exemplary embodiment.

FIG. 5 illustrates a flow chart for implementing a check fraud detection module in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

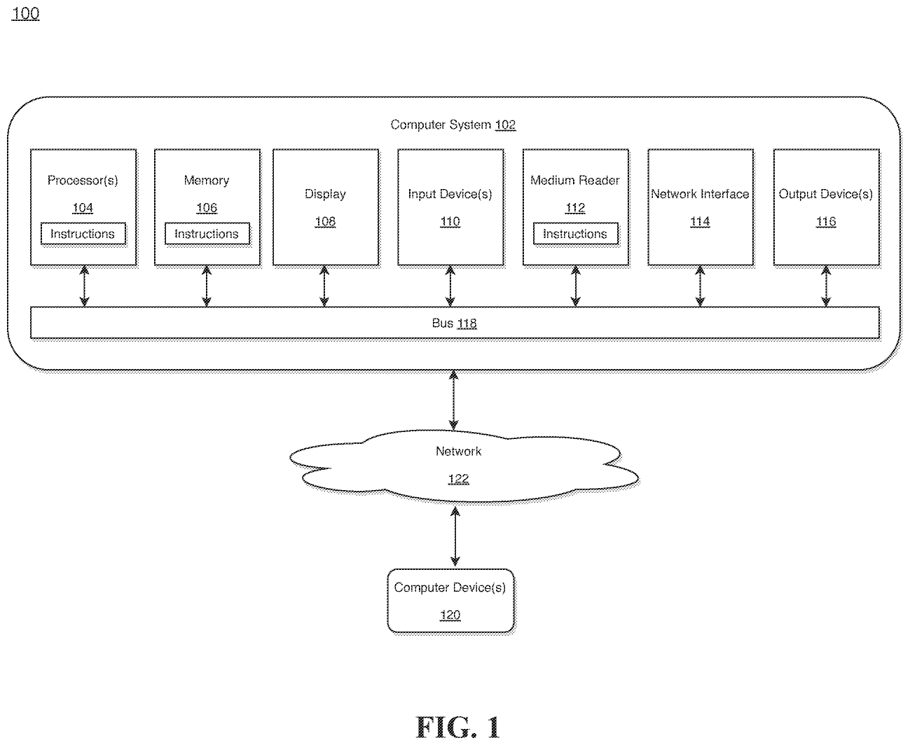

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (OPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of implementing a fraud check detection module for automatically detecting and identifying fraudulent checks through check image analysis by utilizing neural networks, machine learning models, and graphics processing units (GPUs), thereby identifying whether a check is fraudulent in real-time upon receiving a digital image of the check. As described herein, various embodiments provide optimized processes of implementing a check fraud detection module in which the generated proprietary real-time fraud detection model (FDM) may handle a large number of received digital images of checks and multiple data sources required by machine learning models, executing the FDMs in real-time using deployment of multiple neural networks in one platform built using a cluster of GPUs and CPUs. According to exemplary embodiments, the check fraud detection module may comprise of compute clusters that implement proprietary machine learning algorithms, using strategic commodity hardware and open-source software reducing overall cost of operations.

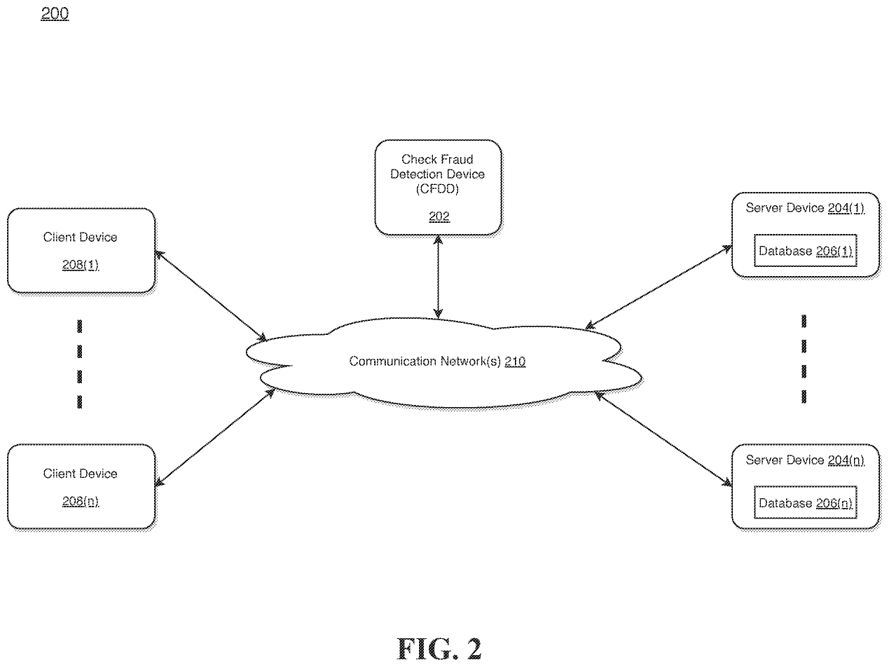

Referring to FIG. 2, a schematic of an exemplary network environment 200 for implementing a check fraud detection device (CFDD) of the instant disclosure is illustrated.

Conventional fraud detection system, that does not implement a CFDD of the instant disclosure, may not be able to process a large amount of data sets and multiple data sources required by machine learning models and may not be able to execute the models in real-time using transaction data from various products and channels. This is because, conventional fraud models are typically deployed on expensive, centralized mainframe computers handing only a single source of data and may not be frequently updated because models had to be manually recoded.

According to exemplary embodiments, the above-described problems associated with conventional approach of executing machine learning models may be overcome by implementing CFDD 202 as illustrated in FIG. 2. The CFDD 202 may be the same or similar to the computer system 102 as described with respect to FIG. 1. The CFDD 202 may store one or more applications that can include executable instructions that, when executed by the CFDD 202, cause the CFDD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CFDD 202 itself, may be located in virtual server(s) running in a cloud-based computing environment rather than being tied to one or more specific physical network computing devices. Also, the application(s) may be running in one or more virtual machines (VMs) executing on the CFDD 202. Additionally, in one or more embodiments of this technology, virtual machine(s) running on the CFDD 202 may be managed or supervised by a hypervisor.

In the network environment 200 of FIG. 2, the CFDD 202 is coupled to a plurality of server devices 204(1)-204(n) that hosts a plurality of databases 206(1)-206(n), and also to a plurality of client devices 208(1)-208(n) via communication network(s) 210. A communication interface of the CFDD 202, such as the network interface 114 of the computer system 102 of FIG. 1, operatively couples and communicates between the CFDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

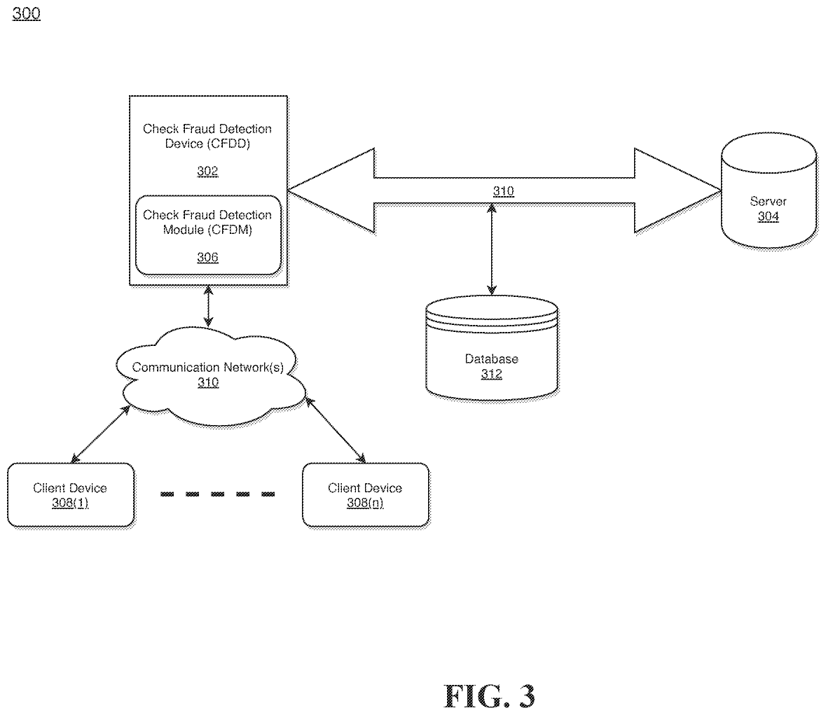

The communication network(s) 210 may be the same or similar to the network 122 as described with respect to FIG. 1, although the CFDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CFDDs that significantly decreased time to deploy fraud models with an automated deployment and the ability to run models simultaneously by eliminating the need to manually recode model changes. This is made possible by using, according to exemplary embodiments, latest open source tools and following industry practices to migrate models from development to production using, for example, model serialization in predictive model markup language (PMML)/Booster file formats instead of recoding. The CFDDs, according to exemplary embodiments may also use Casandra based operational data store, across multiple data centers/sources (see, e.g., channel data source 313 as illustrated in FIG. 3) with real-time replication for business continuity, to track and use real-time customer behaviors/activities arising from e.g., card usage in the middle of the transaction authorization process. This technology also provides real-time simulation environment for enhanced model training and upgrades which will described in detail below with reference to FIG. 3.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CFDD 202 may be a standalone device or integrated with one or more other devices or apparatuses, such as one or more of the server devices 204(1)-204(n), for example. In one particular example, the CFDD 202 may include or be hosted by one of the server devices 204(1)-204(n), and other arrangements are also possible. Moreover, one or more of the devices of the CFDD 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CFDD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the CFDD 202 that may efficiently detect fraudulent checks in real time. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The implementation of the CFDD 202, according to exemplary embodiments, into a proprietary distributed fraud machine learning production platform owned by the instant assignee has shown significant savings in fraud loss, see, e.g., Appendix A and Appendix B. Some exemplary benefits of implementation of the CFDD 202 of the instant disclosure may include: ability to leverage more data sources for detecting fraudulent checks in real time, improving fraud detection accuracy and reduced false-positives by using cross channel data and real-time aggregates; increased capability to spot patterns and irregularities in customer behaviors/activities arising from transactions, or fraud, more efficiently and effectively; improved customer experience at point of check deposit or in-check clearing as they experience fewer disruptions, etc., but the disclosure is not limited thereto.

The client devices 208(1)-208(n) may run interface applications, such as standard web browsers or standalone client applications, which may provide an interface to communicate with the CFDD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the CFDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CFDD 202, the server devices 204(1)-204(n), or the client devices 208(1)-208(n), for example, may be configured to operate as virtual instances on the same physical machine. For example, one or more of the CFDD 202, the server devices 204(1)-204(n), or the client devices 208(1)-208(n) may operate on the same physical device rather than as separate devices communicating through communication network(s) 210. Additionally, there may be more or fewer CFDDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

FIG. 3 illustrates a system diagram for implementing a check fraud detection device (CFDD) having a check fraud detection module (CFDM) in accordance with an exemplary embodiment.

As illustrated in FIG. 3, the system 300 may include a CFDD 302 within which a CFDM 306 is embedded, a server 304, a database 312, a plurality of client devices 308(1) . . . 308(n), and a communication network 310.

According to exemplary embodiments, the CFDD 302 including the CFDM 306 may be connected to the server 304 and the database 312, via the communication network 310. The CFDD 302 may also be connected to the plurality of client devices 308(1) . . . 308(n) via the communication network 310, but the disclosure is not limited thereto. According to exemplary embodiments, the machine learning models may be trained using CPUs and GPUs, but the disclosure is not limited thereto.

According to exemplary embodiment, the CFDD 302 is described and shown in FIG. 3 as including the CFDM 306, although it may include other rules, policies, modules, databases, or applications, for example. According to exemplary embodiments, the database 312 may be embedded within the CFDD 302. According to exemplary embodiments, the database 312 may be configured to store information including preauthorized historical reference 128-dimensional embedding of a signature relating to an account holder, but the disclosure is not limited thereto. For example, the embedding, as disclosed herein, is not limited to 128 dimensions. According to exemplary embodiments, the embedding of a signature may have 32 dimensions, 64 dimensions, 256 dimensions, or any other desired dimensions without departing from the scope of the instant disclosure.

According to exemplary embodiments, the CFDM 306 may be configured to receive real-time feed of data (e.g., digital images of checks) from the plurality of client devices 308(1) . . . 308(n) via the communication network 310.

As will be described below, the CFDM 306 may be configured to provide a platform to detect fraudulent checks by analyzing the received check images from the plurality of client devices 308(1) . . . 308(n). The CFDM 306 may be configured to detect forgery signatures by comparing signature on the received check images with customer's good signature that is already being stored onto the database 312. The CFDM 306 may also be configured to analyze check stock using an object detection neural network and parse items on the check (e.g., check serial numbers, check amounts. DDA account level information, maker name, payee name, signature, memo, date, etc.) using a neural network (see, e.g., Appendix A and Appendix B), but the disclosure is not limited thereto. In addition, the CFDM 306 may be configured to deploy multiple neural networks in one platform that was built using a cluster of GPU's and CPU's (see, e.g., Appendix A and Appendix B). As illustrated in Appendix A and Appendix B, the CFDM 306 may utilize a stack of neural networks models to identify forgery checks; a GPU-based cluster to execute multiple models for each check; and deploy newly developed or re-trained models without re-coding.

The plurality of client devices 308(1) . . . 308(n) are illustrated as being in communication with the CFDD 302. In this regard, the plurality of client devices 308(1) . . . 308(n) may be “clients” of the CFDD 302 and are described herein as such. Nevertheless, it is to be known and understood that the plurality of client devices 308(1) . . . 308(n) need not necessarily be “clients” of the CFDD 302, or any entity described in association therewith herein. Any additional or alternative relationship may exist between either or both of the plurality of client devices 308(1) . . . 308(n) and the CFDD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the CFDD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The CFDD 303 may be the same or similar to the CFDD 202 as described with respect to FIG. 2, including any features or combination of features described with respect thereto.

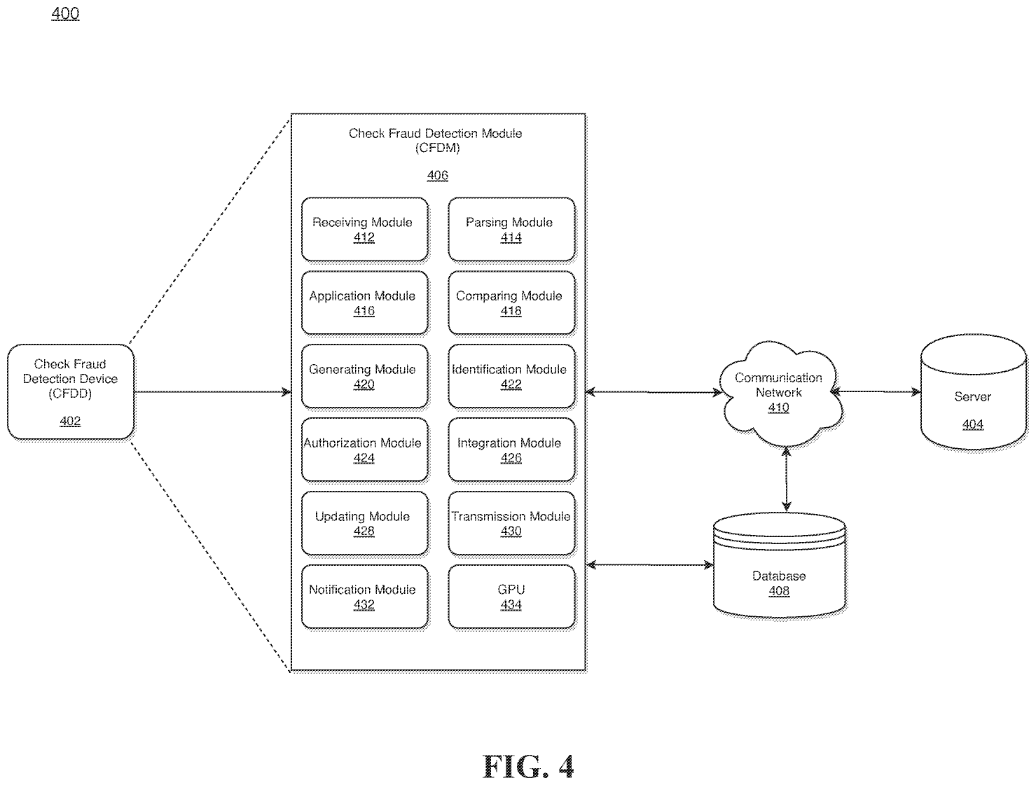

FIG. 4 illustrates a system diagram for implementing a CFDM in accordance with an exemplary embodiment.

According to exemplary embodiments, the system 400 may include a CFDD 402 within which a CFDM 406 is embedded, a server 404, a database 408, and a communication network 410.

According to exemplary embodiments, the CFDD 402 including the CFDM 406 may be connected to the server 404 and the database 408, via the communication network 410. The CFDD 402 may also be connected to the plurality of client devices (not shown) via the communication network 310, but the disclosure is not limited thereto. These client devices may be the same or similar to the client devices 308(1) . . . 308(n) as illustrated in FIG. 3.

According to exemplary embodiments, as illustrated in FIG. 4, the CFDM 406 may include a receiving module 412, a parsing module 414, an application module 416, a comparing module 418, a generating module 420, an identification module 422, an authorization module 424, an integration module 426, an updating module 428, a transmission module 430, a notification module 432, and one or more GPUs 434.

According to exemplary embodiments, each of the receiving module 412, the parsing module 414, the application module 416, the comparing module 418, the generating module 420, the identification module 422, the authorization module 424, the integration module 426, the updating module 428, the transmission module 430, and the notification module 432 of the CFDM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 412, the parsing module 414, the application module 416, the comparing module 418, the generating module 420, the identification module 422, the authorization module 424, the integration module 426, the updating module 428, the transmission module 430, and the notification module 432 of the CFDM 406 may be implemented by microprocessors or similar, and may be programmed using software (e.g., microcode) to perform various functions discussed herein and may optionally be driven by firmware and/or software. Alternatively, according to exemplary embodiments, each of the receiving module 412, the parsing module 414, the application module 416, the comparing module 418, the generating module 420, the identification module 422, the authorization module 424, the integration module 426, the updating module 428, the transmission module 430, and the notification module 432 of the CFDM 406 may be may be implemented by dedicated hardware, or as a combination of dedicated hardware to perform some functions and a processor (e.g., one or more programmed microprocessors and associated circuitry) to perform other functions.

According to exemplary embodiments, each of the receiving module 412, the parsing module 414, the application module 416, the comparing module 418, the generating module 420, the identification module 422, the authorization module 424, the integration module 426, the updating module 428, the transmission module 430, and the notification module 432 of the CFDM 406 may be called via corresponding API, but the disclosure is not limited thereto.

According to exemplary embodiments, the database 408 may store preauthorized historical reference 128-dimensional embeddings of signatures relating to an account holder. A pre-trained model may be utilized to generate these 128-dimensional embeddings of signatures. For example, a residual network (e.g., a ResNet-50) may be utilized for the generation of the 128-dimensional embeddings of a signature, but the disclosure is not limited thereto.

According to exemplary embodiments, the receiving module 412 may be configured to receive a digital image of a check that includes a signature of the account holder. The parsing module 414 may be configured to parse the digital image of the check into separate portions, one of the portions including the signature of the account holder.

According to exemplary embodiments, the application module 416 may be configured to apply a machine learning model (e.g., a pre-trained model) to generate a new 128-dimensional embedding of the signature of the account holder parsed from the received digital image of the check by the parsing module 414.

According to exemplary embodiments, the comparing module 418 may be configured to compare the new 128-dimensional embedding of the signature with the preauthorized historical reference 128-dimensional embedding of the signature by accessing the database 408.

According to exemplary embodiments, the generation module 420 may be configured to generate, based on comparing, a similarity score between the new 128-dimensional embedding of the signature and the preauthorized historical reference 128-dimensional embedding of the signature. Exemplary similarity scores are illustrated in Appendix A and Appendix B.

According to exemplary embodiments, the identification module 422 may be configured to identify whether the received check is fraudulent or not based on the generated similarity score.

According to exemplary embodiments, the identification module 422 may be configured to identify that the received check is not fraudulent based on a determination that the similarity score is a value that is at or above a predetermined threshold value, and the authorization module 424 may be configured to automatically authorize processing of the received check.

According to exemplary embodiments, after determining by the identification module 422 that the received check is not fraudulent, the integration module 426 may be configured to integrate the new 128-dimensional embedding of the signature with the preauthorized historical reference 128-dimensional embedding of the signature, and the updating module 428 may be configured to update the machine learning model by automatically incorporating model changes, due to integration of the new 128-dimensional embedding of the signature with the preauthorized historical reference 128-dimensional embedding of the signature, by the integration module 426, without recoding the model changes.

According to exemplary embodiments, the identification module 422 may be configured to identify that the received check is fraudulent based on a determination that the similarity score is a value that is below a predetermined threshold value, and authorization module 424 may be configured to automatically deny processing of the received check.

According to exemplar embodiments, the transmission module 430 may be configured to transmit the received check, that has been determined to be fraudulent by the identification module 422, to a computing device (not shown) for visual inspection of the signature in the received check with a preauthorized historical reference signature of the account holder.

According to exemplary embodiments, the notification module 432 may be configured to automatically notify the account holder via an electronic message or voice message that the received check has been denied for further processing.

According to exemplary embodiments, the CFDM 406 may be configured to utilize any one of the following as an open source framework to model the machine learning model: Java Spring Boot, Cassandra, LogStash, Kibana, and Kafka, but the disclosure is not limited thereto.

According to exemplary embodiments, in applying the machine learning model, the generation module 420 may be configured to generate a stack of neural networks models, and the CFDM 406 may be configured to utilize the GPU 434 as GPU-based cluster to execute a plurality of neural networks models from the stack of neural networks models for the received digital image of the check to identify whether the received check is fraudulent.

As illustrated in Appendix A and Appendix B, the model may work in the following manners, but the disclosure is not limited thereto. For example, the model may first extract the signatures with a localizer, then feed the two extracted signatures, one to each stack, and then output a similarity score that the two checks' signatures are from the same person.

According to exemplary embodiments, as illustrated in Appendix A and Appendix B, the training process for the model may include the following, but the disclosure is not limited thereto. For example, during the training process of the model, approximately 3,500 signatures may be manually labeled (approximately 20 mm pairs by bucketing checks into people for several hundred accounts); designing a stack to accommodate people who wrote few checks. According to exemplary embodiments, each training batch may be a 50-50 balance with all pairs from same people and a random sample of different people to balance the batch. As illustrated in Appendix A and Appendix B, the CFDM 406 generated approximately 97.7% peak validation accuracy whether a signature in check is fraudulent.

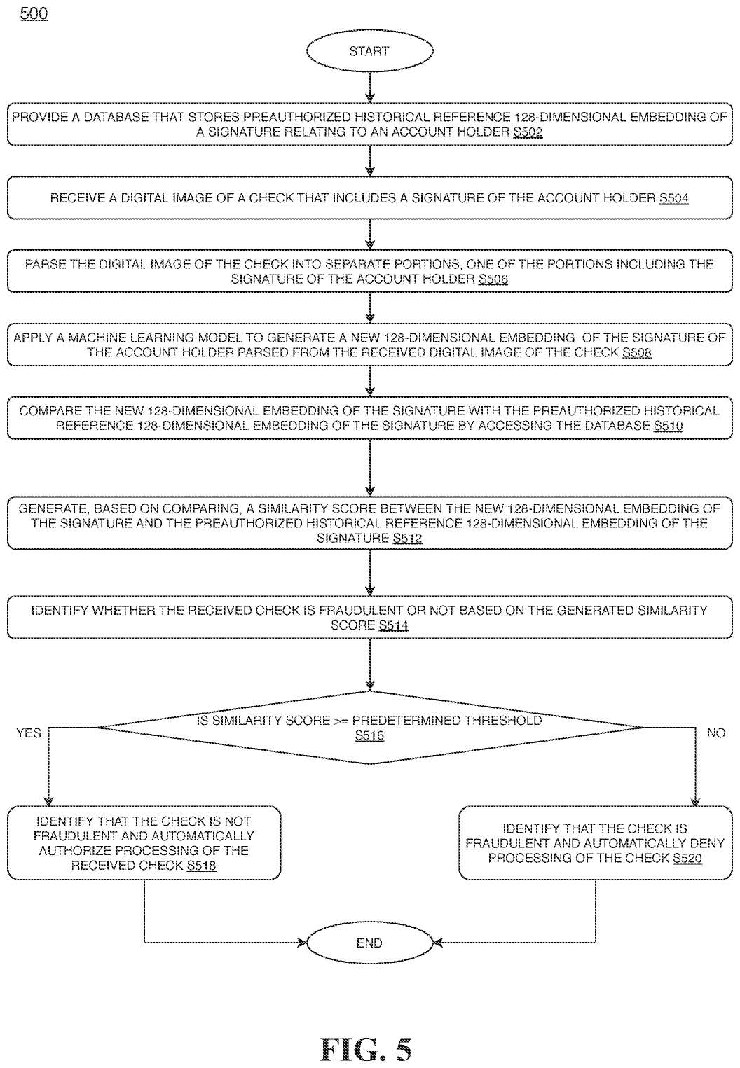

FIG. 5 illustrates a flow chart for implementing a check fraud detection module in accordance with an exemplary embodiment.

In the process 500 of FIG. 5, at step S502, a database may be provided that stores preauthorized historical reference 128-dimensional embedding of a signature relating to an account holder.

At step S504, a digital image of a check may be received that includes a signature of the account holder.

At step S506, the digital image of the check may be parsed into separate portions. One of the portions may include the signature of the account holder.

At step S508, a machine learning model may be applied to generate a new 128-dimensional embedding of the signature of the account holder parsed from the received digital image of the check.

At step S510, the new 128-dimensional embedding of the signature may be compared with the preauthorized historical reference 128-dimensional embedding of the signature by accessing the database. At step S512, based on comparing, a similarity score may be generated between the new 128-dimensional embedding of the signature and the preauthorized historical reference 128-dimensional embedding of the signature.

At step S514, the process 500 identifies whether the received check is fraudulent or not based on the generated similarity score. For example, at step S516, the process 500 determines whether the similarity score is more than or equal to a predetermined threshold value. When it is determined in step S516 that the similarity score is more than or equal to a predetermined threshold value, at step S518, the process 500 identifies that the check is not fraudulent and automatically authorizes processing of the received check. When it is determined in step S516 that the similarity score is less than a predetermined threshold value, at step S520, the process 500 identifies that the check is fraudulent and automatically denies processing of the received check.

According to exemplary embodiments, the process 500 may further include: integrating the new 128-dimensional embedding of the signature with the preauthorized historical reference 128-dimensional embedding of the signature: and updating the machine learning model by automatically incorporating model changes, due to integration of the new 128-dimensional embedding of the signature with the preauthorized historical reference 128-dimensional embedding of the signature, without recoding the model changes.

According to exemplary embodiments, the process 500 may further include: transmitting the received check, that has been determined to be fraudulent, to a computing device for visual inspection of the signature in the received check with a preauthorized historical reference signature of the account holder.

According to exemplary embodiments, the process 500 may further include: automatically notifying the account holder via an electronic message or voice message that the received check has been denied for further processing.

According to exemplary embodiments, the process 500 may further include: utilizing any one of the following as an open source framework to model the machine learning model: Java Spring Boot, Cassandra, LogStash, Kibana, and Kafka.

According to exemplary embodiments, the process 500 may further include: generating a stack of neural networks models, and utilizing a graphics processing unit (GPU) based cluster to execute a plurality of neural networks models from the stack of neural networks models for the received digital image of the check to identify whether the received check is fraudulent.

According to exemplary embodiments, the CFDD 402 may include a memory (e.g., a memory 106 as illustrated in FIG. 1) which may be a non-transitory computer readable medium that may be configured to store instructions for implementing a CFDM 406 for implementing a rules based configurable solution for good order that covers stale data checks, agreement data quality checks, etc., and for automatically validating against the configured rules standard deviation to determine if the data is acceptable or not as disclosed herein. The CFDD 402 may also include a medium reader (e.g., a medium reader 112 as illustrated in FIG. 1) which may be configured to read any one or more sets of instructions, e.g., software, from any of the memories described herein. The instructions, when executed by a processor embedded within the CFDM 406 or within the CFDD 402, may be used to perform one or more of the methods and processes as described herein. In a particular embodiment, the instructions may reside completely, or at least partially, within the memory 106, the medium reader 112, and/or the processor 104 (see FIG. 1) during execution by the CFDD 402.

According to exemplary embodiments, the processor 104 as illustrated in FIG. 1 or the processor embedded within CFDD 202, CFDD 302, CFDD 402, and CFDM 406 is described herein to utilize signature similarity score to identify a fraudulent check, but the disclosure is not limited thereto. According to exemplary embodiments, the processor 104 as illustrated in FIG. 1 or the processor embedded within CFDD 202. CFDD 302, CFDD 402, and CFDM 406 may be configured to utilize any one or more of the following processes to identify a fraudulent check without departing from the scope of the instant disclosure: check stock analysis: results of parsing text on the check; past check and other transaction histories for the customers involved; past suspicious activity on the accounts involved, etc.

According to exemplary embodiments, the instructions, when executed, may further cause the processor 104 to perform the following: identifying that the received check is not fraudulent based on a determination that the similarity score is a value that is at or above a predetermined threshold value; and automatically authorizing processing of the received check.

According to exemplary embodiments, the instructions, when executed, may further cause the processor 104 to perform the following: integrating the new 128-dimensional embedding of the signature with the preauthorized historical reference 128-dimensional embedding of the signature; and updating the machine learning model by automatically incorporating model changes, due to integration of the new 128-dimensional embedding of the signature with the preauthorized historical reference 128-dimensional embedding of the signature, without recoding the model changes.

According to exemplary embodiments, the instructions, when executed, may further cause the processor 104 to identify that the received check is fraudulent based on a determination that the similarity score is a value that is below a predetermined threshold value, and automatically denying processing of the received check.

According to exemplary embodiments, the instructions, when executed, may further cause the processor 104 to apply a neural network to convert the printed or handwritten “Pay to the order of” field to text, identify that a check is fraudulent based on suspicious “Pay to the order of” entries, identify that a check is not fraudulent based on safe “Pay to the order of” entries.

According to exemplary embodiments, the instructions, when executed, may further cause the processor 104 to perform the following: transmitting the received check, that has been determined to be fraudulent, to a computing device for visual inspection of the signature in the received check with a preauthorized historical reference signature of the account holder.

According to exemplary embodiments, the instructions, when executed, may further cause the processor 104 to perform the following: automatically notifying the account holder via an electronic message or voice message that the received check has been denied for further processing, but the disclosure is not limited thereto.

According to exemplary embodiments, the instructions, when executed, may further cause the processor 104 to perform the following: utilizing any one of the following as an open source framework to model the machine learning model: Java Spring Boot, Cassandra, LogStash, Kibana, and Kafka, but the disclosure is not limited thereto.

According to exemplary embodiments, the instructions, when executed, may further cause the processor 104 to perform the following: generating a stack of neural networks models; and utilizing a graphics processing unit (GPU) based cluster to execute a plurality of neural networks models from the stack of neural networks models for the received digital image of the check to identify whether the received check is fraudulent.

Although according to the above exemplary use case, the CFDM 406 detects check fraud by analyzing the signature block of a check, the CFDM 406 may also be configured to detect check fraud by analyzing the maker name or the payee name and applying the similar processes disclosed above with respect to FIGS. 3-5.

For example, the database 408 may store preauthorized historical reference 128-dimensional embeddings of maker names and/or payee names relating to an account holder. A pre-trained model may be utilized to generate these 128-dimensional embeddings of maker names and/or payee names. For example, a residual network (e.g., a ResNet-50) may be utilized for the generation of the 128-dimensional embeddings of a maker name and/or a payee name, but the disclosure is not limited thereto.

According to exemplary embodiments, the receiving module 412 may be configured to receive a digital image of a check that includes a maker name and/or a payee name of the account holder. The parsing module 414 may be configured to parse the digital image of the check into separate portions, one of the portions including the maker name and/or the payee name of the account holder.

According to exemplary embodiments, the application module 416 may be configured to apply a machine learning model (e.g., a pre-trained model) to generate a new 128-dimensional embedding of the maker name and/or the payee name of the account holder parsed from the received digital image of the check by the parsing module 414.

According to exemplary embodiments, the comparing module 418 may be configured to compare the new 128-dimensional embedding of the maker name and/or the payee name with the preauthorized historical reference 128-dimensional embedding of the maker name and/or the payee name by accessing the database 408.

According to exemplary embodiments, the generation module 420 may be configured to generate, based on comparing, a similarity score between the new 128-dimensional embedding of the maker name and/or the payee name and the preauthorized historical reference 128-dimensional embedding of the maker name and/or the payee name. Exemplary similarity scores are illustrated in Appendix A and Appendix B. According to exemplary embodiments, the identification module 422 may be configured to identify whether the received check is fraudulent or not based on the generated similarity score.

According to exemplary embodiments, the identification module 422 may be configured to identify that the received check is not fraudulent based on a determination that the similarity score is a value that is at or above a predetermined threshold value, and the authorization module 424 may be configured to automatically authorize processing of the received check.

According to exemplary embodiments as disclosed above in FIGS. 1-5, technical improvements effected by the instant disclosure may include a single platform for implementing a fraud check detection module for automatically detecting and identifying fraudulent checks through check image analysis by utilizing neural networks, machine learning models, and graphics processing units (GPUs), thereby identifying whether a check is fraudulent in real-time upon receiving a digital image of the check. Implementation of the CFDMs of the instant disclosure may significantly decrease time to deploy fraud models with an automated deployment and the ability to run models simultaneously by eliminating the need to manually recode model changes.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for implementing a check fraud detection module to detect a fraudulent check by utilizing one or more processors and one or more memories, the method comprising:
providing a database that stores preauthorized historical reference 128-dimensional embedding of a signature relating to an account holder;
receiving a digital image of a check that includes a signature of the account holder;
parsing the digital image of the check into separate portions, one of the portions including the signature of the account holder;
applying a machine learning model to generate a new 128-dimensional embedding of the signature of the account holder parsed from the received digital image of the check;
comparing the new 128-dimensional embedding of the signature with the preauthorized historical reference 128-dimensional embedding of the signature by accessing the database;
generating, based on comparing, a similarity score between the new 128-dimensional embedding of the signature and the preauthorized historical reference 128-dimensional embedding of the signature; and
identifying whether the received check is fraudulent or not based on the generated similarity score.

2. The method according to claim 1, further comprising:
identifying that the received check is not fraudulent based on a determination that the similarity score is a value that is at or above a predetermined threshold value; and
automatically authorizing processing of the received check.

3. The method according to claim 2, further comprises:
integrating the new 128-dimensional embedding of the signature with the preauthorized historical reference 128-dimensional embedding of the signature; and
updating the machine learning model by automatically incorporating model changes, due to integration of the new 128-dimensional embedding of the signature with the preauthorized historical reference 128-dimensional embedding of the signature, without recoding the model changes.

4. The method according to claim 1, further comprising:
identifying that the received check is fraudulent based on a determination that the similarity score is a value that is below a predetermined threshold value; and
automatically denying processing of the received check.

5. The method according to claim 4, further comprises:
transmitting the received check, that has been determined to be fraudulent, to a computing device for visual inspection of the signature in the received check with a preauthorized historical reference signature of the account holder.

6. The method according to claim 4, further comprising:
automatically notifying the account holder via an electronic message or voice message that the received check has been denied for further processing.

7. The method according to claim 1, further comprising:
utilizing any one of the following as an open source framework to model the machine learning model: Java Spring Boot, Cassandra, LogStash, Kibana, and Kafka.

8. The method according to claim 1, wherein applying a machine learning model further comprising:
generating a stack of neural networks models; and
utilizing a graphics processing unit (GPU) based cluster to execute a plurality of neural networks models from the stack of neural networks models for the received digital image of the check to identify whether the received check is fraudulent.

9. A system for implementing a check fraud detection module to detect a fraudulent check, comprising:
a database that stores preauthorized historical reference 128-dimensional embedding of a signature relating to an account holder; and
a processor operatively connected to the database via a communication network, wherein the processor is configured to:
receive a digital image of a check that includes a signature of the account holder;
parse the digital image of the check into separate portions, one of the portions including the signature of the account holder;
apply a machine learning model to generate a new 128-dimensional embedding of the signature of the account holder parsed from the received digital image of the check;
compare the new 128-dimensional embedding of the signature with the preauthorized historical reference 128-dimensional embedding of the signature by accessing the database;
generate, based on comparing, a similarity score between the new 128-dimensional embedding of the signature and the preauthorized historical reference 128-dimensional embedding of the signature; and
identify whether the received check is fraudulent or not based on the generated similarity score.

10. The system according to claim 9, wherein the processor is further configured to:
identify that the received check is not fraudulent based on a determination that the similarity score is a value that is at or above a predetermined threshold value; and
automatically authorize processing of the received check.

11. The system according to claim 10, wherein the processor is further configured to:
integrate the new 128-dimensional embedding of the signature with the preauthorized historical reference 128-dimensional embedding of the signature; and
update the machine learning model by automatically incorporating model changes, due to integration of the new 128-dimensional embedding of the signature with the preauthorized historical reference 128-dimensional embedding of the signature, without recoding the model changes.

12. The system according to claim 9, wherein the processor is further configured to:
identify that the received check is fraudulent based on a determination that the similarity score is a value that is below a predetermined threshold value; and
automatically deny processing of the received check.

13. The system according to claim 12, wherein the processor is further configured to:
transmit the received check, that has been determined to be fraudulent, to a computing device for visual inspection of the signature in the received check with a preauthorized historical reference signature of the account holder.

14. The system according to claim 12, wherein the processor is further configured to:
automatically notify the account holder via an electronic message or voice message that the received check has been denied for further processing.

15. The system according to claim 9, wherein the processor is further configured to:
utilize any one of the following as an open source framework to model the machine learning model: Java Spring Boot, Cassandra, LogStash, Kibana, and Kafka.

16. The system according to claim 9, wherein in applying a machine learning model, the processor is further configured to:
generate a stack of neural networks models; and
utilize a graphics processing unit (GPU) based cluster to execute a plurality of neural networks models from the stack of neural networks models for the received digital image of the check to identify whether the received check is fraudulent.

17. A non-transitory computer readable medium configured to store instructions for implementing a check fraud detection module to detect a fraudulent check, wherein when executed, the instructions cause a processor to perform the following:
accessing a database that stores preauthorized historical reference 128-dimensional embedding of a signature relating to an account holder;
receiving a digital image of a check that includes a signature of the account holder;
parsing the digital image of the check into separate portions, one of the portions including the signature of the account holder;
applying a machine learning model to generate a new 128-dimensional embedding of the signature of the account holder parsed from the received digital image of the check;
comparing the new 128-dimensional embedding of the signature with the preauthorized historical reference 128-dimensional embedding of the signature by accessing the database;
generating, based on comparing, a similarity score between the new 128-dimensional embedding of the signature and the preauthorized historical reference 128-dimensional embedding of the signature; and
identifying whether the received check is fraudulent or not based on the generated similarity score.

18. The non-transitory computer readable medium according to claim 17, wherein the instructions, when executed, causes the processor to further perform the following:
integrating the new 128-dimensional embedding of the signature with the preauthorized historical reference 128-dimensional embedding of the signature; and
updating the machine learning model by automatically incorporating model changes due to integration of the new 128-dimensional embedding of the signature with the preauthorized historical reference 128-dimensional embedding of the signature, without recoding the model changes.

19. The non-transitory computer readable medium according to claim 17, wherein the instructions, when executed, causes the processor to further perform the following:
identifying that the received check is fraudulent based on a determination that the similarity score is a value that is below a predetermined threshold value; and
automatically denying processing of the received check.

20. The non-transitory computer readable medium according to claim 17, wherein the instructions, when executed, causes the processor to further perform the following:
transmitting the received check, that has been determined to be fraudulent, to a computing device for visual inspection of the signature in the received check with a preauthorized historical reference signature of the account holder.
